(19) United States
(12) Patent Application Publication
(10) Pub. No.: US 2010/0247753 A1
(43) Pub. Date: Sep. 30, 2010

(54) SOLAR HEAT CUTOFF PAVEMENT

(75) Inventors: Nobuyuki Nemoto, Tokyo (JP); Tamotsu Yoshinaka, Tokyo (JP); Seiki Nagashima, Tokyo (JP); Keigo Kinoshita, Tokyo (JP); Noriyuki Fukae, Tokyo (JP)

Correspondence Address: DILWORTH & BARRESE, LLP, 1000 WOODBURY ROAD, SUITE 405, WOODBURY, NY, 11797, US

(73) Assignees: NIPPO CORPORATION, Tokyo (JP); NAGASHIMA SPECIAL PAINT CO., LTD., Tokyo (JP); HOUSE-TECH CO., LTD, Tokyo (JP)

(21) Appl. No.: 12/794,917

(22) Filed: Jun. 7, 2010

Related U.S. Application Data
(62) Division of application No. 10/499,573, filed on Jun. 21, 2004, now abandoned.

(30) Foreign Application Priority Data
Dec. 20, 2001 (JP) 2001-387363

(51) Int. Cl. B05D 5/06

(52) U.S. Cl. 427/137

(57) ABSTRACT

A solar heat cutoff asphalt pavement road is provided by applying a coating composition comprising (a) a resin as a binder and (b) at least one blackish pigment having a solar radiation reflectance defined by JIS A 5759 of not less than 15% and an L* value in CIE 1976 L*a*b* color space of not larger than 30, onto the substantially entire surface of said pavement to form a coated top surface layer on the pavement.

### FIELD OF THE INVENTION

The present invention relates to a method for suppressing a rise of a road surface temperature caused by solar heat.

### BACKGROUND OF THE INVENTION

Paved bodies, a typical example of which is an asphalt pavement (or paved road), are apt to absorb solar radiation energy and the surface of a road using a pavement is apt to rise in temperature particularly in the summer season. In urban areas, as a measure against environment, including head island phenomenon, or as a measure for improving a thermal environment of pedestrian space for pedestrians, it is desired to develop a pavement having a function of suppressing a rise of the road surface temperature. However, a pavement which exhibits a satisfactory effect has not been developed yet. The development of a pavement capable of suppressing a rise (reducing a peak temperature) of the road surface temperature is keenly desired.

### SUMMARY OF THE INVENTION

It is an object of the present invention to provide a method for providing a solar heat cutoff asphalt pavement road which satisfies the above-mentioned demand.

The present invention resides in a method for controlling a rise of an asphalt road pavement surface temperature which comprises applying a coating composition comprising (a) a resin as a binder and (b) at least one blackish pigment having a solar radiation reflectance defined by JIS A 5759 of not less than 15% and an L* value in CIE 1976 L*a*b* color space of not larger than 30, onto the substantially entire surface of said pavement to form a coated top surface layer on the pavement.

### BRIEF DESCRIPTION OF THE DRAWING

FIG. 1 is a graph showing a specimen surface temperature for each of various color tones of pavements in Examples;

FIG. 2 is a graph showing a reflectance at each of various wavelengths of an azomethiazo black pigment used in Examples; and

FIG. 3 is a graph showing a reflectance at each of various wavelengths of a dark brown pigment used in Examples.

### DETAILED DESCRIPTION OF THE INVENTION

The pavement as referred to herein means an asphalt pavement road typically for vehicular passage thereon. As the pavement of the present invention there are included both existing and newly-formed pavements.

In the preferable embodiment, the coating composition further contains hollow fine particles.

As the hollow fine particles used in the prevent invention, inorganic hollow fine particles are preferred. Particularly, transparent or translucent ceramic hollow fine particles are preferred. Above all, ceramic hollow fine particles having a strength of not lower than 40 kgf/cm² are preferred. As composition examples of such ceramics are mentioned zirconia-titania composite, silicon boride ceramics, shirasu (white sandy sediment) balloon, and glass balloon. A preferred particle diameter is in the range of 5 to 150 μm. Air or any other gas than air may be present in the interior of each hollow body, or the hollow body interior may be vacuum. The state of vacuum (the vacuum as referred to herein means a lower state than atmospheric pressure) is more effective for example from the standpoint of heat insulation.

As to the pigment used in the present invention which absorbs solar heat in the visible wavelength region and reflects solar heat in the infrared wavelength region, a preferred example is one whose solar radiation reflectance in the wavelength region of 350 to 2100 nm defined by JIS A 5759 is not less than 15% and whose L* value in CIE 1976 L*a*b* color space is not larger than 30, more preferably not larger than 24.

The solar radiation reflectance in the wavelength region of 350 to 2100 nm defined by JIS A 5759 means a solar radiation reflectance obtained by measuring spectral reflectances at 36 wavelength points divided at every wavelength spacing of 50 nm from 350 nm to 2100 nm in wavelength with use of a spectrophotometer and by subsequently making calculation in accordance with the following equation, wherein R_{E} stands for a solar radiation reflectance (%), Eλᵢ stands for a spectral distribution value of solar radiation, and Rλᵢ stands for a spectral reflectance.

R_{E}=(Σ₃₅₀²¹⁰⁰EλᵢRλᵢ/Σ₃₅₀²¹⁰⁰Eλᵢ)×100

Table 1 below shows a spectral distribution of solar radiation at every wavelength.

TABLE 1
Spectral distribution of solar radiation (Eλᵢ)

| | | |
|---|---|---|
| Wavelength | Wavelength | Wavelength |

| | | | | | |
|---|---|---|---|---|---|
| λ₁ | Eλ₁ | λ₁ | Eλ₁ | λ₁ | Eλ₁ |

| | | |
|---|---|---|
| (nm) | (nm) | (nm) |

| | | | | | |
|---|---|---|---|---|---|
| 350 | 1.27 | 950 | 3.29 | 1,550 | 1.49 |
| 400 | 3.18 | 1,000 | 4.25 | 1,600 | 1.36 |
| 450 | 6.79 | 1,050 | 3.72 | 1,650 | 1.17 |
| 500 | 8.20 | 1,100 | 1.70 | 1,700 | 0.89 |
| 550 | 8.03 | 1,150 | 1.46 | 1,750 | 0.54 |
| 600 | 7.88 | 1,200 | 2.52 | 1,800 | 0.01 |
| 650 | 7.92 | 1,250 | 2.21 | 1,850 | 0.00 |
| 700 | 7.48 | 1,300 | 1.78 | 1,900 | 0.00 |
| 750 | 5.85 | 1,350 | 0.12 | 1,950 | 0.12 |
| 800 | 5.79 | 1,400 | 0.00 | 2,000 | 0.02 |
| 850 | 5.66 | 1,450 | 0.16 | 2,050 | 0.26 |
| 900 | 3.24 | 1,500 | 1.06 | 2,100 | 0.58 |
| | | | | Total | 100.00 |

Most of the pigments commonly used exhibit absorption in both visible and infrared wavelength regions and thus pigments which satisfy the conditions defined above in the present invention are extremely limited. Many of the pigments employable in the present invention exhibit such an outstanding effect as being blackish (including dark brown) but nevertheless being superior in solar heat cutoff characteristic.

Chemical structures of the pigments employable in the present invention are not limited insofar as they possess the above characteristic, which pigments can be easily selected by confirming the above characteristic experimentally with respect to known organic and inorganic pigments. As an example there are mentioned azo pigments of the following general formula which have a particle size of 0.3 to 10 μm and which are proposed in Japanese Patent Publication No. 26348/1992:

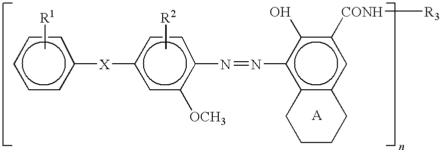

where X is N═N or CONH, n is 1 or 2, R₁ is a hydrogen atom or a nitro group, R₂ is a halogen atom or a methoxy group, ring A is the benzene ring or the naphthalene ring, and when n is 1, R₃ is a phenyl group which may optionally contain halogen atom, methyl group, nitro group or methoxy group, or a naphthyl group having no substituent group, when n is 2, R₃ is a biphenylene group which may contain a methoxy group.

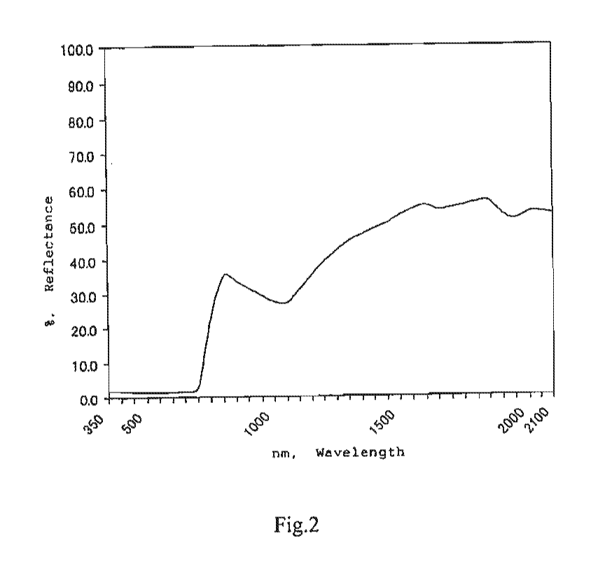

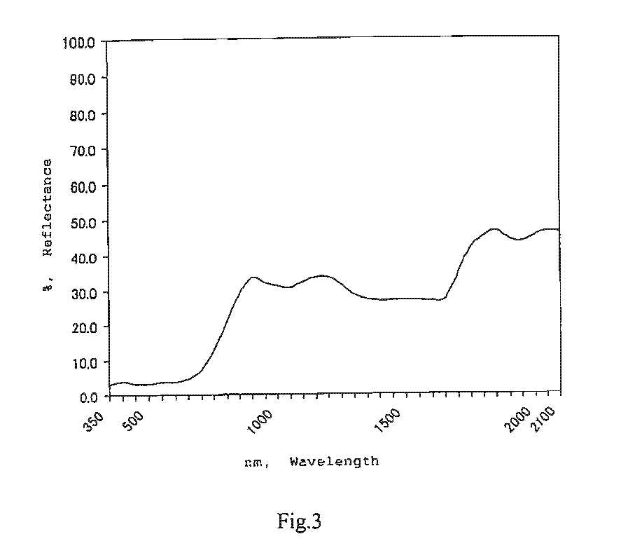

As an example of a commercially available pigment which satisfies the above conditions there is mentioned an azomethiazo black pigment which is available under the trade name of Chromofine Black A-1103 [a product of Dainichiseika Colour & Chemicals Mfg. Co. (Dainichiseika Kogyo)]. The particle size in this pigment is 0.3 to 10 μm. Its reflectances at various wavelengths are shown in FIG. 2. A dark brown pigment having such a reflection characteristic as shown in FIG. 3 also satisfies the above conditions.

In addition to the pigment which satisfies the above conditions, it is also preferable to use a colored pigment defined by JIS A 5759 and exhibiting a solar radiation reflectance of not less than 12% in the wavelength region of 350 to 2100 nm, and a white pigment as necessary. As examples of colored pigments which satisfies this condition there are mentioned yellow pigments such as monoazo yellow (trade name: Hostaperm Yellow H3G, a product of Hoechst Co.), iron oxide (trade name: Toda Color 120 ED, a product of Toda Kogyo Corp.), red pigments such as quinacridone red (trade name: Hostaperm Red E2B70, a product of Hoechst Co.), blue pigments such as phthalocyanine blue (trade name: Cyanine Blue SPG-8, a product of Dainippon Ink And Chemicals Incorporated), and green pigments such as phthalocyanine green (trade name: Cyanine Green 5310, a product of Tainichiseika Colour & Chemicals Mfg. Co.).

Solar radiation reflectance data are measured in a fully hidden (covered) state, more specifically in a state of a coating having a hiding (covering) ratio of about 1.0.

As examples of the white pigment which may be used as necessary there are mentioned titanium oxide and zinc white.

As preferred examples of the method for causing hollow fine particles and/or a pigment which absorbs solar heat in the visible wavelength region and reflects solar heat in the infrared wavelength region to be present in the surface layer portion of the pavement according to the present invention, there mentioned a method wherein the hollow fine particles and/or the pigment are mixed into an asphalt mixture (containing aggregates, etc.) which constitutes a surface layer of an ordinary asphalt pavement, a method wherein the hollow fine particles and/or the pigment are mixed into a binder or the like and the resulting mixture is applied to the surface of the pavement, a method wherein the hollow fine particles and/or the pigment are mixed into a cement slurry and the resulting mixture is filled into surface gaps of the pavement such as open-graded asphalt concrete, and a method wherein the hollow fine particles and/or the pigment are spread over the surface of the pavement which is in a softened state and are allowed to adhere and be mixed into the pavement surface layer.

Particularly preferred examples of the binder are resins having such durability and weathering resistance as permit them to be used in road traffic, as well as asphalt, asphalt emulsions, and cements. Preferred examples of such resins include crosslinking type resin compositions such as vinyl ester resin, unsaturated polyester (meth)acrylate resin, epoxy (meth)acrylate resin, urethane (meth)acrylate resin, and methyl (meth)acrylate resin. Particularly, room temperature curing radical crosslinking type resin compositions are preferred. Radical crosslinking type resin compositions are well-balanced in all of adhesion, quick curing property, abrasion resistance, and weathering resistance and in this point they are suitable for application to the pavement of the present invention.

Such a radical crosslinking type resin composition is usually supplied in a two-package type and two solutions are mixed together on the spot when be to be applied to the pavement. In the present invention it is most preferred to adopt a method wherein two solutions each incorporating therein hollow fine particles and/or a predetermined pigment are sprayed onto a road surface simultaneously and continuously with use of a two-head type spray gun.

Binder resins employable in the present invention are not limited to those referred to above, but there may be used both water-soluble type and solvent type resins insofar as they are superior in adhesion, quick curing property, abrasion resistance and weathering resistance.

In case of mixing hollow fine particles into the binder, it is sometimes difficult to form a stable dispersion, which is attributable to the viscosity of the binder and a difference in specific gravity between the binder and the hollow fine particles. In such a case it is preferable to use a suitable structure holding agent. As examples of structure holding agents for resin and asphalt (mixture) there are mentioned composites of acrylamide derivatives, polyethylene oxide wax and/or organic bentonite with silica particles. As acrylamide derivatives, polyfunctional acrylamides such as di- and triacrylamides are preferred. Particularly preferred are acrylamide derivatives wherein acrylamide groups are interconnected through a long-chain hydrocarbon group such as an alkylene group having 20 to 30 carbon atoms. As examples of structure holding agents for asphalt emulsion there are mentioned composites of cellulose derivatives, acrylic polymers, polyvinyl alcohols and/or organic bentonite with silica particles. Examples of cellulose derivatives include hydroxyethyl cellulose and carboxymethyl cellulose.

The amount of the pigment and hollow fine particles, if any, which absorb solar heat in the visible wavelength region and reflects solar heat in the infrared wavelength region is not specially limited insofar as it is sufficient to suppress a rise of the surface temperature of the pavement caused by solar heat. In principle, there is obtained a solar heat cutoff effect proportional to the said amount. When the surface layer portion of the pavement is seen in the vertical direction, the area of hollow fine particles present therein (the ratio of area hidden by the presence of hollow fine particles when a vertical line is transmitted in the sectional direction) is usually 20% or more, preferably 50% or more.

The thickness of the surface layer which contains hollow fine particles differs depending on for example the kind of material which constitutes the surface layer, but is usually 0.5 mm or more, preferably 1 mm or more. An upper limit of the thickness is not specially limited, but is 5 mm or so in the case where hollow fine particles are applied in a mixed state into a binder or the like.

When the amount of hollow fine particles is represented in terms of a composition concentration, it is usually in the range of 10 to 70 vol. %, preferably 15 to 60 vol. %, relative to a surface coating layer (components exclusive of aggregates in case of hollow fine particles being mixed into the paving material in which case coatings are formed on the surfaces of the aggregates). The amount of the pigment which absorbs solar heat in the visible wavelength region and reflects solar heat in the infrared wavelength region can be determined suitably according to a hiding power and applied color, but is preferably in the range of 5 to 50 wt. %.

The pigment may be used independently, but a greater effect is obtained when both of the pigment and the hollow fine particles are used in combination.

The hollow fine particles are usually applied to the whole of a pavement surface for which a solar heat cutoff effect is expected, but may also be applied to a part of the pavement surface. By using the pigment, a blackish surface layer is formed in the present invention. However, in case of a pavement other than the pavement for road, such as pool side or tennis court, a non-black surface layer may be formed taking a sense of beauty into account.

The pavement having the surface layer portion according to the present invention can effectively reduce the amount of solar energy absorbed onto the surface of the pavement and hence can suppress a rise in temperature of the pavement surface. Consequently, it is possible to decrease a long wave radiation quantity and a sensible heat transfer quantity from the pavement surface. That is, it is possible to make contribution to the improvement of urban environment and pedestrian environment. Moreover, since it is possible to reduce a maximum road surface temperature in an asphalt pavement, the occurrence of rutting can be controlled, thus leading to the improvement in utility of the pavement.

Further, in an asphalt pavement such as a water drainable pavement, its surface is uneven due to aggregates, etc. present in the surface layer, so that a principal area of the pavement surface is occupied the other portion than convex top portions. Therefore, there is little deterioration of effect even if the surface layer becomes worn due to contact thereof with running wheels, and it is possible to ensure a stable effect over a long period.

### EXAMPLE

Working examples of the present invention will be described below, but the invention is not limited thereto.

### Example 1

Specimens (t=5 cm) for wheel tracking test were fabricated using a dense-graded asphalt mixture (13 mm TOP), then were installed outdoors (in Shinagawa-ku, Tokyo) and measured for surface temperature. In fabricating the specimens, a room temperature curing, radical crosslinking type vinyl ester resin composition having durability sufficient for use in road traffic was used as a binder, then hollow fine particles, a structure holding agent, and pigments absorbing solar heat in the visible wavelength region and reflecting solar heat in the infrared wavelength region were incorporated into the binder to form road coating materials, which were then applied onto the upper surfaces of the specimens.

As the hollow fine particles there were used hollow fine ceramic particles having a residue content on 149 μm sieve of not more than 1% and a true specific gravity of 0.37.

TABLE 2

| | | | Name of |
|---|---|---|---|
| | Type | Trade Name | Manufacturer |
| Pigment A | Black | Chromofine | Dainichiseika |
| | pigment | Black A-1103 | Kogyo |
| Pigment B | Dark Brown | Dyepyroxide | Dainichiseika |
| | pigment | Brown 9290 | Kogyo |
| Pigment C | Yellow | Hostaperm | Hoechst |
| | pigment | Yellow H3G | |
| Pigment D | Blue | Cyanine | Dainippon Ink |
| | pigment | Blue SPG-8 | |
| Pigment E | White | Taipake CR-90 | Ishihara Titan |
| | pigment | | |

Pigments A and B are pigments having a solar radiation reflectance defined by JIS A 5759 of not less than 15% and an L* value in CIE 1976 L*a*b* color space of not more than 30.

Mixing compositions are as shown in Table 3 below.

TABLE 3

| Name of Material | Colorless | Black | White | Gray |
|---|---|---|---|---|
| Pigment A | | 6.9 | | |
| Pigment B | | | | 5.2 |
| Pigment C | | | | 5.8 |
| Pigment D | | | | 0.1 |
| Pigment E | | | 36.2 | 19.9 |
| Vinyl ester resin | 89.5 | 82.6 | 53.3 | 58.5 |
| Hollow fine particles | 6.0 | 6.0 | 6.0 | 6.0 |
| Fine particle silica | 3.7 | 3.7 | 3.7 | 3.7 |
| Organic bentonite | 0.8 | 0.8 | 0.8 | 0.8 |
| Total | 100.0 | 100.0 | 100.0 | 100.0 |

*The values in the above table are in weight percent.

As to the paved body using a road coating material with hollow fine particles incorporated in a colorless binder resin, a temperature reducing effect of 3° to 4° C. was recognized in all of the following Runs 1 to 3.

Next, the paved bodies using the road coating materials of the above mixing compositions were checked for the exhibition of effect against the influence of meteorological conditions such as daylight hours in both fine summer condition and rainy season.

### Run 1) Color Tone and Temperature Reducing Effect

When sunlight is applied to a pavement surface, if the pavement surface is back in color, it is easier to absorb solar radiation, so that the road surface temperature is apt to rise, while a white road surface is apt to reflect solar radiation and therefore the temperature thereof is difficult to rise. In this Run 1, paved bodies according to the present invention (hereinafter referred to as “pavement(s) according to the invention”) were measured for surface temperature under varying color tones and studies were made about a temperature reducing effect obtained when the tone is set at black color as in the conventional asphalt pavement (“standard” hereinafter) and that obtained when gray and white colors were adopted which colors were expected to make a greater contribution to suppressing a rise of the road surface temperature.

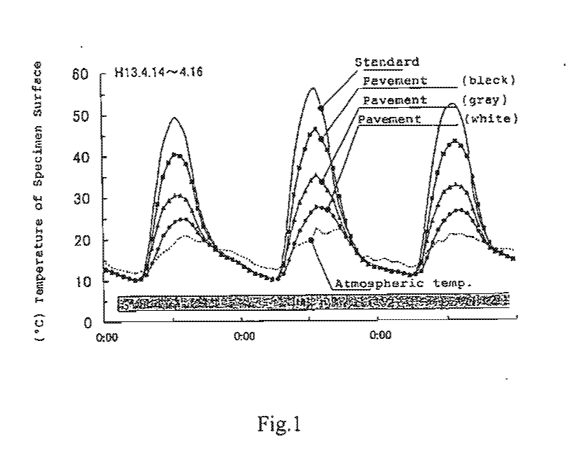

The measurement was made for three fine days in April, 2001 at an atmospheric temperature of 23° C. From the results of the measurement shown in FIG. 1 it is seen that, when comparison is made between the standard and the pavement (black) according to the invention, the highest road surface temperature of the standard reaches about 56° C. on the second day, while that of the pavement according to the invention is about 46° C., and that this temperature difference of about 10° C. corresponds to a direct temperature reducing effect.

On the other hand, when comparison is made among the pavements according to the present invention with respect to highest road surface temperatures at different color tones, it is seen that on the second day the highest road surface temperature in gray color is about 35° C. and that in white color is about 27° C. and that the temperature reducing effect becomes greater as the pavement tone becomes brighter. Differences in highest road surface temperature from the standard were about 21° C. in gray color and about 29° C. in white color. Values obtained by measuring albedo were about 0.08 to 0.10 in the standard, about 0.20 to 0.28 in gray color, and about 0.43 to 0.48 in white color (close to 0.44 in concrete), and thus it can be presumed that the temperature reducing effect obtained by brightening the pavement tone is based on a synergistic effect between the effect attained by the present invention and the suppression of incident solar radiation exhibited by the change in albedo.

When it is assumed that any of the pavements according to the invention is applied to an actual road, gray color is appropriate as the pavement tone, taking both temperature reducing effect and visibility into account. For this reason, gray color was selected as the pavement tone to be used in the following Runs 2 to 4.

### Run 2) Characteristics in Fine Summer Weather

In Run 2, a study will be made about a road surface temperature reducing effect of the pavement according to the invention in a fine weather condition. An experiment was conducted in accordance with the method described in Run 1 and the pavement tone was set at the gray color selected in Run 1. The period of measurement was seven fine summer days in July, 2001, during which period the highest atmospheric temperature was about 35° C.

Reference to Table 7 shows that the standard exhibited highest road surface temperatures of about 60° C. in the entire period except the third day of less daylight hours, while highest road surface temperatures in the case of the pavement according to the present invention were about 43° C. Also on the third day of less daylight hours, the highest road surface temperature in the pavement according to the present invention, which was about 39° C., was lower than that in the standard which was about 49° C. The difference in temperature of the pavement according to the present invention from the standard proved to reach a maximum of about 20° C. in the measurement period of seven days.

Thus, in the summer season in which the road surface temperature is apt to rise under solar radiation, the pavement according to the present invention has the effect of suppressing a rise of the road surface temperature while suppressing albedo to about 0.2.

### Run 3) Characteristics in Cloudy or Rainy Weather

In Run 3, a study will be made about a difference in the exhibition of effect caused by a difference in weather conditions including daylight hours. The study will be made by comparing the results of measurement of road surface temperatures in cloudy and rainy weathers with the results of measurement in a fine weather obtained in Run 2. The period of measurement was seven days in the rainy season of June, 2001. In the measurement period, the highest atmospheric temperature was about 28° C. and the amount of rainfall was a total of 68 mm.

Reference to Table 7 shows that on the first day on which it rained intermittently the highest road surface temperature in the standard was about 27° C., while that in the pavement according to the invention was about 24° C., and that on the fifth day the highest road surface temperature in the standard was about 37° C., while that in the pavement according to the invention was about 29° C. Thus, also in cloudy and rainy weather conditions the pavement according to the invention exhibited a lower highest road surface temperature. A difference in temperature of the pavement according to the invention from the standard, though varying depending on the amount of rainfall and atmospheric temperature, was found to be a maximum of about 3° to 10° C. even on a day on which daylight hours were not observed.

From the above it is seen that the pavement according to the invention can afford a road surface temperature suppressing effect even in the case where the daylight period is short. This is for the following reason. Even in the case where there is little daylight period as in a cloudy or rainy weather, there exists a long wave radiation from the atmosphere, but solar heat in the infrared wavelength region is reflected by the pavement according to the present invention, whereby a rise of the road surface temperature is suppressed.

### Run 4) Long Wave Radiation Quantity and Sensible Heat Transfer Quantity

In Run 4, long wave radiation quantities and sensible heat transfer quantities in the fine summer weather in Run 2 and in the rainy season in Run 3 were calculated and tabulated in Table 4.

A comparison of average values of long wave radiation quantities in the fine summer weather shows that a value of about 539 W/m² is in the case of the standard and a value of about 496 W/m² is in the case of the pavement according to the invention. Thus, the pavement according to the invention exhibited a value lower by about 8% on the average. A comparison between maximum values in the measurement period shows that the pavement according to the invention exhibited a decrease of about 145 W/m² and thus suppresses the long wave radiation quantity in the daytime in which the same radiation quantity becomes maximum. Also as to the long wave radiation quantity in the rainy season period as a short daylight period, a decrease of about 6% on the average was exhibited. Thus, a long wave radiation suppressing effect of the pavement according to the invention was recognized as a general tendency irrespective of weather conditions.

Also as to the sensible heat transfer quantity, like the long wave radiation quantity, it is seen that the pavement according to the invention exhibits a lesser tendency than the standard. A look at Table 4 shows that the rate of decrease in sensible heat transfer quantity in the measurement period of seven days in June and that in July are 55.9% and 56.1%, respectively. That the sensible heat transfer quantity at which the pavement surface warms up the atmosphere directly can be decreased as much as about 56% is because the temperature of the road surface using the pavement according to the invention becomes lower than that in the standard on the average. The rate of decrease in sensible heat quantity in June and that in July are almost constant. This suggests that the rate of decrease scarcely changes even if weather conditions such as daylight hours and the amount of rainfall differ greatly.

From the above it turned out that the pavement according to the invention could suppress a rise of the road surface temperature and could decrease the road surface temperature about 20° C. in comparison with the standard even at an albedo of about 0.20 to 0.28 (gray color) at which the amount of reflected solar radiation is suppressed in comparison with a concrete pavement. In the case of white color corresponding to the same degree of albedo as that of a concrete pavement, a road surface temperature decreasing effect reaches a maximum of about 29° C. This result was obtained also in Run 1. Taking into account the point that the long wave radiation quantity and the sensible heat transfer quantity depend on the road surface temperature, a pavement exhibiting a higher temperature reducing effect and thereby capable of making contribution to the improvement of urban environment and pedestrian environment can be obtained by making a further study about a pavement surface applicable to actual roads.

TABLE 4
Total 7-day values of the pavement
according to the invention

| | | Measurement Period | | | |
|---|---|---|---|---|---|
| | | H13 6/6-6/12 | | H13 7/4-7/10 | |
| | | Type of Pavement | | | |
| | | | Pavement | | Pavement |
| | | | according | | according |
| | | | to the | | to the |
| | | Standard | Invention | Standard | Invention |
| Long Wave | Mean Value | 472.2 | 445.2 | 538.8 | 495.5 |
| Radiation | (W/m²) | | | | |
| Quantity | Rate of | — | 5.7 | — | 8.0 |
| δ Ts⁴ | Decrease (%) | | | | |
| | Maximum Value | 675.3 | 521.9 | 736.1 | 591.2 |
| | (W/m²) | | | | |
| | Minimum Value | 411.9 | 413.6 | 439.1 | 438.5 |
| | (W/m²) | | | | |
| Sensible | Mean Value | 36.3 | 16.0 | 56.9 | 25.0 |
| Heat | (W/m²) | | | | |
| Transfer | Rate of | — | 55.9 | — | 56.1 |
| Quantity H | Decrease (%) | | | | |
| | Maximum Value | 252.5 | 92.9 | 286.5 | 122.9 |
| | (W/m²) | | | | |
| | Minimum Value | −10.1 | −8.7 | −4.6 | −6.2 |
| | (W/m²) | | | | |

| | | | |
|---|---|---|---|
| Atmospheric | Mean Value | 21.4 | 27.9 |
| Temperature | (° C.) | | |
| | Highest Temp. | 28.3 | 34.5 |
| | (° C.) | | |
| | Lowest Temp. | 18.6 | 23.1 |
| | (° C.) | | |
| Daylight | Total Value in | 1452 | 3854 |
| Hours | the period | | |
| | (h) | | |
| Rainfall | Total Value in | 68 | 0 |
| | the period | | |
| | (mm) | | |
| Wind | Mean Value in | 2.7 | 2.6 |
| Velocity | the period | | |
| | (m/h) | | |

| | | |
|---|---|---|
| Remarks | Rainy season | Fine summer weather |

In the sensible heat transfer quantity, plus indicates the transfer of heat from the pavement side to the atmosphere side, while minus indicates the transfer of heat from the atmosphere side to the pavement side.
   Run 5) Comparison of Temperature Reducing Effect in Case of Hollow Fine Particles and/or a Pigment being Incorporated in Gray Coating Materials which Pigment Absorbs Solar Heat in the Visible Wavelength Region and Reflects Solar Heat in the Infrared Wavelength Region

Each of coating materials (a), (b), (c) and (d) shown in Table 5 was sprayed in an amount of 800 g/m² onto an asphalt specimen (10 cm×10 cm×5 cm) and dried thoroughly, then was subjected to radiation under a reflector lamp (150 W). The temperature detected upon stop of a temperature rise was regarded as a highest surface temperature.

TABLE 5
Comparison of temperature reducing effect in
case of hollow fine particles and/or the pigment
in question being incorporated in gray coating
materials and compositions of the coating
materials

Highest Surface Temperature
(° C.) under Lamp Radiation

| Measurement Results | (a) | (b) | (c) | (d) |
|---|---|---|---|---|
| Surface Temp. | 66.1 | 63.1 | 46.2 | 43.7 |
| Temperature Difference | ±0 | −3.0 | −19.9 | −22.4 |

Compositions (%)

| Material Name | (a) | (b) | (c) | (d) |
|---|---|---|---|---|
| Pigment B (the | 0 | 0 | 5.5 | 5.2 |
| pigment in question) | | | | |
| Pigment F | 0.3 | 0.3 | 0 | 0 |
| (carbon black) | | | | |
| Hollow Fine Particles | 0 | 6.3 | 0 | 6.0 |
| Pigment C | 6.5 | 6.1 | 6.2 | 5.8 |
| Pigment D | 0.1 | 0.1 | 0.1 | 0.1 |
| Pigment E | 22.3 | 20.9 | 21.2 | 19.9 |
| Vinyl Ester Resin | 65.7 | 61.6 | 62.2 | 58.5 |
| Fine Particle Silica | 4.2 | 3.9 | 3.9 | 3.7 |
| Organic Bentonite | 0.9 | 0.8 | 0.9 | 0.8 |
| Total | 100.0 | 100.0 | 100.0 | 100.0 |

(a): a conventional gray coating material (containing neither hollow fine particles nor the pigment in question)
(b): a coating material with only hollow fine particles incorporated therein
(c): a coating material with only the pigment in question incorporated therein
(d): a coating material with both hollow fine particles and the pigment in question incorporated therein
(Note 1) The temperature difference in the table has been calculated assuming that the highest surface temperature in case of using the coating material (a) is a standard (±0).
(Note 2) In this experiment the pigment in question indicates the pigment which absorbs solar heat in the visible wavelength region and reflects solar heat in the infrared wavelength region.
(Note 3) Pigments B, C, D, and E in the table correspond to the pigments B, C, D, and E, respectively, in Table 2.
(Note 4) Pigment F in the table is a conventional black pigment (carbon black).

### (Testing Method)

Each of the coating materials (a), (b), (c), and (d) was sprayed to an asphalt specimen (10 cm×10 cm×5 cm) in an amount of 800 g/m² (400 g/m²× twice) and was thoroughly dried, thereafter was subjected to radiation under a reflector lamp (150 W). The temperature measured upon stop of a temperature rise was regarded as the highest surface temperature.

### (Experiment Results)

As a result of the experiment, when the coating material with only the pigment in question incorporated therein was used, there was obtained a temperature reducing effect of about 19.9° C. in comparison with the standard, and even when the coating material with only hollow fine particles incorporated therein was used, there was obtained a temperature reducing effect of about 3.0° C. Further, a more outstanding temperature reducing effect was obtained when the coating material with both hollow fine particles and the pigment in question incorporated therein was used.

### Example 2

In this Example, a radical crosslinking type methyl (meth)acrylate resin was used as a binder and a coating composition comprising the binder and hollow fine particles, a structure holding agent and a pigment all incorporated in the binder, the pigment absorbing solar heat in the visible wavelength region and reflecting solar heat in the infrared wavelength region, was applied to a surface portion of an existing asphalt pavement. Execution of the coating composition applying work was checked and a comparison was made between the temperature of the coating composition-applied road surface and the temperature of a road surface not coated with the coating composition.

For curing the coating composition there was adopted a method using a two-package type room temperature curing resin. More specifically, there was prepared a composition comprising a radical crosslinking type methyl (meth)acrylate resin as a binder and hollow fine particles, a structure holding agent and a pigment all incorporated in the binder, the pigment absorbing solar heat in the visible wavelength region and reflecting solar heat in the infrared wavelength region, then a curing agent was incorporated in the composition prepare a composition A and there also was prepared a composition B by incorporating a reaction accelerator in the above composition. The compositions A and B are mixed together for reaction and curing. Generally, when the work for applying a road surface coating material (e.g., a coating composition) onto a road surface is carried out on a pavement in use, it is required to complete the work within a limited time under traffic control, so in many cases there is used a two-package type room temperature curing resin which reacts and cures rapidly.

In the coating composition applying work in this experiment, pressure is applied by a pump to the coating composition which is liquid prior to reaction, causing the composition to be fed under pressure up to a spray gun through a hose, and the composition is sprayed onto a road surface portion by the spray gun. In this case, if both compositions A and B are mixed in advance and the resulting mixture is pumped, there will occur curing of resin within the pump or hose during the coating work, with consequent likelihood of the coating work becoming difficult. According to the method adopted in this experiment in view of the point just mentioned, the compositions A and B are fed under pressure through separate hoses by separate pumps up to the spray gun, then were mixed together in the interior of the spray gun, and the resulting mixture is sprayed. By adopting this method, the coating work could be carried out in a satisfactory manner without curing of the compositions within the pumps and hoses. After mixing of both compositions and curing in the interior of the spray gun, the resulting mixture cured in about 15 minutes, and in about 20 minutes it cured to the extent of withstanding traffic use.

On a day late in August on which the highest atmospheric temperature was about 36° C., highest road surface temperatures in the daytime of paved bodies according to the invention coated with the coating composition and a conventional asphalt pavement (standard) not coated with the coating composition are as shown in Table 6. In the pavement (black) according to the invention, despite black color like the standard, the highest road surface temperature in the daytime decreased as much as about 10° C. as compared with that in the standard, and in the case of the pavement (gray) according to the invention there was recorded a decrease of as much as about 17° C.

TABLE 6
Comparison of road surface temperature between the
pavements according to the invention and the standard

| | Highest Road | Temperature |
|---|---|---|
| | Surface | Difference |
| Measurement | Temperature in | (difference from |
| Place | Day time | the standard) |
| Pavement | 51.3° C. | −10.4° C. |
| according to the | | |
| invention (black) | | |
| Pavement | 44.4° C. | −17.3° C. |
| according to the | | |
| invention (gray) | | |
| Standard (black) | 61.7° C. | |

(Note)
The pavements according to the invention are based on asphalt pavements.

TABLE 7
Results of road surface temperature
measurement in rainy season and in fine
summer weather

| | | | Measurement Period | | | | | |
|---|---|---|---|---|---|---|---|---|
| | | | Rainy Season | | | Fine Summer Weather | | |
| | | | (H13 6/6-6/12) | | | (H13 7/4-7/10) | | |
| | | | Type of Pavement | | | | | |
| | | | | Pavement | | | Pavement | |
| | | | | according | | | according | |
| | | | | to the | Temp. | | to the | Temp. |
| | | | Standard | invention | Difference | Standard | invention | Difference |
| Measurement | 1st | Highest road | 26.8 | 24.0 | −2.8 | 61.7 | 44.8 | −16.9 |
| Day | day | surface temp. | | | | | | |
| | | Lowest road | 19.1 | 19.9 | 0.8 | 25.6 | 25.5 | −0.1 |
| | | surface temp. | | | | | | |
| | 2nd | Highest road | 55.3 | 36.1 | −19.2 | 64.4 | 46.4 | −18.0 |
| | day | surface temp. | | | | | | |
| | | Lowest road | 20.2 | 20.5 | 0.3 | 26.5 | 26.4 | −0.1 |
| | | surface temp. | | | | | | |
| | 3rd | Highest road | 52.3 | 34.0 | −18.3 | 49.2 | 39.9 | −9.3 |
| | day | surface temp. | | | | | | |
| | | Lowest road | 19.0 | 19.4 | 0.4 | 28.1 | 28.0 | −0.1 |
| | | surface temp. | | | | | | |
| | 4th | Highest road | 57.2 | 36.7 | −20.5 | 58.9 | 41.7 | −17.2 |
| | day | surface temp. | | | | | | |
| | | Lowest road | 18.8 | 19.6 | 0.8 | 25.5 | 25.6 | 0.1 |
| | | surface temp. | | | | | | |
| | 5th | Highest road | 37.9 | 29.0 | −8.9 | 63.2 | 43.8 | −19.4 |
| | day | surface temp. | | | | | | |
| | | Lowest road | 21.8 | 21.5 | −0.3 | 23.6 | 23.7 | 0.1 |
| | | surface temp. | | | | | | |
| | 6th | Highest road | 52.6 | 35.7 | −16.9 | 59.7 | 43.2 | −16.5 |
| | day | surface temp. | | | | | | |
| | | Lowest road | 19.9 | 20.9 | 1.0 | 23.7 | 23.6 | −0.1 |
| | | surface temp. | | | | | | |
| | 7th | Highest road | 36.1 | 26.7 | −9.4 | 62.3 | 44.5 | −17.8 |
| | day | surface temp. | | | | | | |
| | | Lowest road | 18.8 | 19.3 | 0.5 | 23.4 | 23.4 | 0.0 |
| | | surface temp. | | | | | | |

(Note 1)
Temperature Difference = Road surface temperature of the pavement according to the invention − road surface temperature of the standard
(Note 2)
Unit: ° C.

What is claimed is:

1. A method for controlling a rise of an asphalt road pavement surface temperature which comprises applying a coating composition comprising (a) a resin as a binder and (b) at least one blackish pigment having a solar radiation reflectance defined by JIS A 5759 of not less than 15% and an L* value in CIE 1976 L*a*b* color space of not larger than 30, onto the substantially entire surface of said pavement to form a coated top surface layer on the pavement.

2. A method according to claim 1 wherein said pigment is an azo pigment having the general formula: 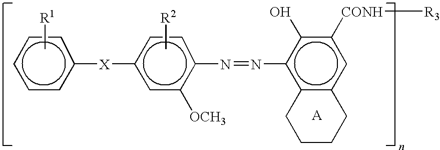
where X is N═N or CONH, n is 1 or 2, R₁ is a hydrogen atom or a nitro group, R₂ is a halogen atom or a methoxy group, ring A is the benzene ring or the naphthalene ring, and when n is 1, R₃ is a phenyl group which may optionally contain halogen atom, methyl group, nitro group or methoxy group, or a naphthyl group having no substituent group, when n is 2, R₃ is a biphenylene group which may contain a methoxy group.

3. A method according to claim 1, wherein said pigment is contained in the amount of 5 to 50 wt. % based on the weight of the coating composition.

4. A method according to claim 1, wherein said binder is a crosslink type resin.

5. A method according to claim 4, wherein said crosslink type resin is vinyl ester resin, unsaturated polyester, (meth)acrylate resin, epoxy (meth)acrylate resin, urethane (meth)acrylate resin, or methyl (meth)acrylate resin.

6. A method according to claim 4, wherein said crosslink type resin is a room temperature curing radical crosslink type resin.

7. A method according to claim 1, wherein said coated top surface layer has a thickness of 0.5 mm to 5 mm.

8. A method according to claim 1, wherein said coating composition further contains hollow fine ceramic particles having a strength of not lower than 40 kgf/cm².

9. A method according to claim 8, wherein said hollow fine ceramic particles are contained in the amount of 10-70 vol. % based on the volume of the coating composition.

10. A method according to claim 1, wherein said coating composition further contains at least one colored pigment having a solar radiation reflectance defined by JIS A 5759 of not less than 12% and optionally a white pigment.
